(19) United States
(12) Patent Application Publication
(10) Pub. No.: US 2025/0295190 A1
(43) Pub. Date: Sep. 25, 2025

(54) FILLING-MATERIAL FILLED CLOTH PRODUCT

(71) Applicant: GOLDWIN INC., Toyama (JP)

(72) Inventors: Yoko IWAMURA, Toyama (JP); Minami HANADA, Toyama (JP); Hironao MATSUDA, Toyama (JP)

(73) Assignee: GOLDWIN INC., Toyama (JP)

(21) Appl. No.: 19/230,081

(22) Filed: Jun. 6, 2025

Related U.S. Application Data
(63) Continuation of application No. PCT/JP2023/045567, filed on Dec. 19, 2023.

(30) Foreign Application Priority Data
Dec. 21, 2022 (JP) 2022-204182

(51) Int. Cl. A41D 31/02; A41D 1/02; A41D 31/06

(52) U.S. Cl. CPC A41D 31/02; A41D 1/02; A41D 31/06

(57) ABSTRACT

A filling-material filled cloth product includes: a pair of fabrics layered together and sewn peripherally at a filling-material partition stitch defining therein a bag-shaped filling-material accommodation space; and a thermally insulating filling material accommodated within the bag-shaped filling-material accommodation space, wherein one fabric of the pair of fabrics is cut so as to be larger than the other fabric of the pair of fabrics so that the one fabric having a surplus portion such as a tuck or dart in proximity to the filling-material partition stitch made as a result of largely cutting is pushed up away from the filling material so as to stand up in a three-dimensional manner from the other fabric, and thereby, the filling-material accommodation space is three-dimensionally shaped so as to accommodate the filling material having a substantially uniform thickness in proximity to the filling-material partition stitch.

### CROSS REFERENCE TO RELATED APPLICATIONS

This is a continuation application of International Patent Application No. PCT/JP2023/045567 filed on Dec. 19, 2023 claiming priority upon Japanese Patent Application No. 2022-204182 filed on Dec. 21, 2022, of which full contents are incorporated herein by reference.

### BACKGROUND OF THE INVENTION

### Field of the Invention

The present invention relates to clothes and other filling-material filled cloth products used for thermal insulation from and protection against low temperatures in cold climate areas.

### Description of the Background Art

There have been conventionally provided filling-material filled clothes each having filing material such as down therein as clothing of a high level of thermal insulation to be worn in cold climate areas. As such a filling-material filled cloth, there have been clothes each manufactured by having a bag-shaped space defined between a front fabric and a lining fabric sewn peripherally and thereafter having filing material in the bag-shaped space, as disclosed in a manufacturing method of manufacturing filling-material filled clothes in, e.g., Patent Document 1. A periphery along which the front fabric and the lining fabric were sewn together has, however, been problematic in terms of a narrower inner space in proximity to the periphery and therefore, a thinner filling material inserted into such a narrower inner space has resulted in a decrease in level of thermal insulation.

As means for solving the above-described problems, there has been disclosed a warming cell pattern for clothing and other outdoor goods in Patent Document 2. The warming cell pattern has been formed so as to have attached thereto a plurality of warming cells having their respective cubic shapes. Each warming cell was attached to fabrics of clothing and other outdoor goods in various manners of attachment. The warming cell had a dart formed at a corner thereof.

### PRIOR ART DOCUMENTS

### Patent Documents

Patent Document 1: Japanese Patent Application Publication No. 2018-71019
Patent Document 2: Japanese Patent Application Publication No. 2022-506307

### Problems to be Solved

As to the above-described means disclosed in Patent Document 2, a level of thermal insulation was high. It was not easy, however, to form such three-dimensionally shaped warming cells at intervals so that an air channel can be generated in each interval between adjacently arranged warming cells, which has resulted in an increase in manufacturing steps.

### SUMMARY OF THE INVENTION

In view of the above-described problems of the background art, there is provided a simply manufactural filling-material filled cloth product having a simple structure configured to maintain a uniform loft thereby enabling a good thermal insulation for a high level of heat retention.

### Means for Solving Problems

One aspect of the present invention is a filling-material filled cloth product comprising: a pair of fabrics layered together and sewn peripherally at filling-material partition stitch defining therein a bag-shaped filling-material accommodation space; and a thermally insulating filling material accommodated within the bag-shaped filling-material accommodation space, wherein one fabric of the pair of fabrics is cut so as to be larger than the other fabric of the pair of fabrics so that the one fabric having a surplus portion such as a tuck or dart in proximity to the filling-material partition stitch made as a result of largely cutting is pushed up away from the filling material so as to stand up in a three-dimensional manner from the other fabric, and thereby, the filling-material accommodation space is three-dimensionally shaped so as to accommodate the filling material having a substantially uniform thickness in proximity to the filling-material partition stitch.

Another aspect of the present invention may be the above-described filling-material filled cloth product, wherein one fabric of the pair of fabrics is a front fabric to be positioned so as to face a wearer's body side, and the other fabric of the pair of fabrics is a lining fabric to be positioned so as to be opposite to the wearer's body side, and wherein the front fabric is cut so as to be larger than the lining fabric so that the front fabric having a tuck or dart formed thereon is pushed up away from the filling material so as to stand up in a three-dimensional manner from the lining fabric.

Still another aspect of the present invention may be the above-described filling-material filled cloth product, wherein: the filling-material accommodation space includes a plurality of filling-material accommodation spaces adjacent to each other; said filling-material filled cloth product is a jacket; or the filling material is made of down.

### Advantageous Effects of the Invention

The filling-material filled cloth product according to the present invention can be manufactured by a simple manufacturing method as having a simple structure whose filing material has a uniform loft so that a good thermal insulation can be maintained for a high level of heat retention. Even a small amount of filling material can be three-dimensionally shaped so efficiently as to have a high level of heat retention. It is, therefore, possible to suppress an amount of filling-material use, which is economical. The cloth is changeable in shape depending upon a plurality of filling-material accommodation spaces therewithin, and it can be in line with a wearer's body shape, and thereby, the wearer's feeling of fit can be enhanced.

### BRIEF DESCRIPTIONS OF THE DRAWINGS

FIG. 1 depicts a front view of a filling-material filled cloth product according to a first embodiment of the present invention.

FIG. 2 depicts a rear view of the filling-material filled cloth product according to the first embodiment of the present invention.

FIG. 3 depicts a partially enlarged perspective view of the filling-material filled cloth product according to the first embodiment of the present invention.

FIG. 4 depicts schematic views showing manufacturing steps (a), (b), (c), and (d), respectively, of the filling-material filled cloth product according to the first embodiment of the present invention.

FIG. 5 depicts A-A line longitudinally cross-sectional views of the filling-material filled cloth product according to the first embodiment of the present invention shown in the schematic view of manufacturing step (d) in FIG. 4.

FIG. 6 depicts a front view of a front fabric (a) and a rear view of a lining fabric (b) of a filling-material filled cloth product according to a second embodiment of the present invention.

FIG. 7 depicts a front view of a front fabric of a filling-material filled cloth product according to a third embodiment of the present invention.

FIG. 8 depicts a graph of a test result of measuring a ratio of heat retention for a filling-material filled cloth product according to an embodiment of the present invention.

FIG. 9 depicts a graph of a test result of measuring a level of power consumption (heat loss) for a filling-material filled cloth product according to an embodiment of the present invention.

### DESCRIPTIONS OF EMBODIMENTS OF THE INVENTION

Hereinafter, embodiments according to the present invention will be described with reference to the drawings.

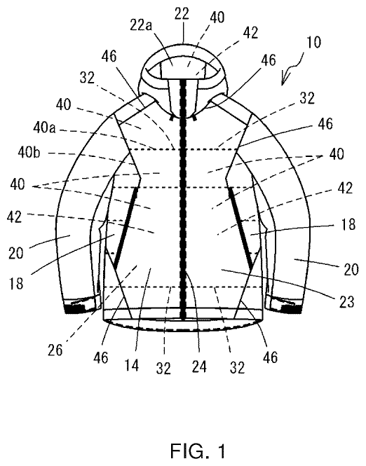

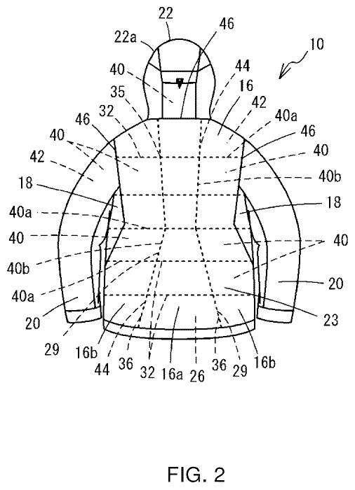

First of all, FIGS. 1 to 5 depict a filling-material filled cloth product according to a first embodiment of the present invention that is a filling-material filled jacket 10 to be worn outdoors in cold climate areas. The jacket 10 having a front side shown in FIG. 1 and a rear side shown in FIG. 2 is provided with parts so as to cover a wearer's upper half body such as: a front panel 14; a back panel 16; side portions 18; sleeve portions 20; a hood portion 22; and the like, sewn together, and is further provided with an outer fabric 23 made of, e.g., GORE-TEX (registered trademark) or the like, where the front panel 14 has a fastener 24 formed at a center line thereof so as to be openable/closable when a wearer takes off/puts on the jacket 10.

The parts cut into their respective shapes each is formed as a result of layering a lining fabric 26 laminated so as to face the outer fabric 23 to a front fabric 28 cut largely in comparison in size to the lining fabric 26 such that the lining fabric 26 is positioned at an opposite side to a wearer's body side and the front fabric 28 is positioned at the wearer's body side, where the front fabric 28 is made of material having a predetermined level of flexibility to such an extent that no particular abnormality occurs in tactile sense for a wearer when contacting a surface of the front fabric 28 during wearing of the jacket 10.

The lining fabric 26 and the front fabric 28 layered together so as to be sewn peripherally at filling-material partition stitch 32 defining therewithin a bag-shaped filling-material accommodation space 40, and a thermally insulating filling material 42 having a heat-retention property is accommodated within the bag-shaped filling-material accommodation space 40, where the filling material 42 is made of, e.g., down. The front fabric 28 formed as a result of largely cutting in comparison in size to the lining fabric 26 has a tuck 35 as a surplus portion formed in proximity to the filling-material partition stitch 32 thereon. The front fabric 28 is pushed up away from the filing material 42 so as to stand up in a three-dimensional manner from the lining fabric 26, that is, the filling-material accommodation space 40 is three-dimensionally shaped. Since the filling-material accommodation space 40 is in a three-dimensional shape, such a space 40 is filled with the filling material 42 maintaining a substantially uniform thickness even in proximity to the filling-material partition stitch 32. A plurality of filling-material accommodation spaces 40, 40 are adjacently arranged across a baffle surfaces 40a, 40a formed as a result of the front fabric 28's standing up substantially perpendicularly from the lining fabric 26 without any significant gap so that the plurality of filling-material accommodation spaces 40, 40 can be filled with their respective filling materials 42, 42 in a substantially continuous manner while maintaining a substantially uniform thickness.

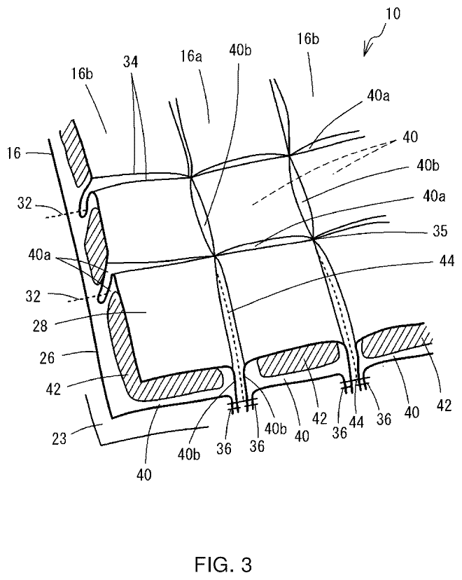

A manufacturing method of manufacturing the jacket 10 according to an embodiment of the present invention will be described based upon FIGS. 3 to 5.

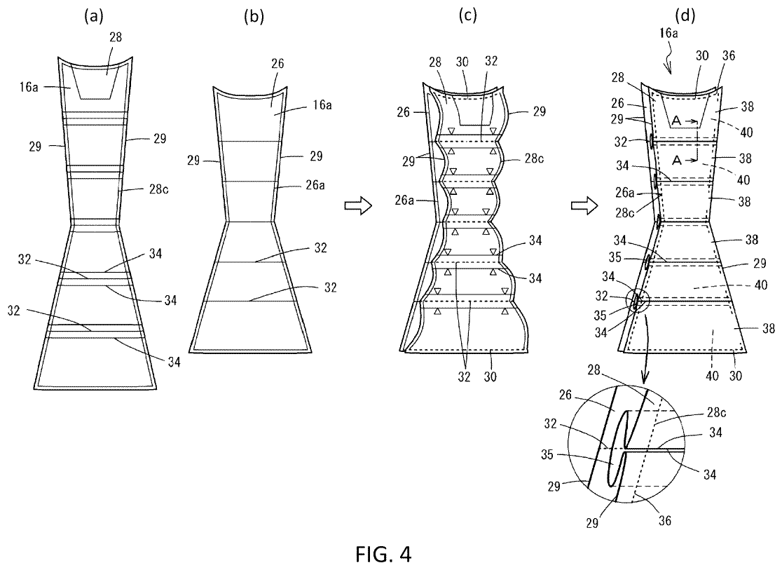

Firstly, a central piece 16a of the back panel 16 will be described. As shown in FIG. 4, such a central piece 16a has a longitudinally elongated shape so as to be continuous from a neck line to a bottom line, and among end portions intersecting laterally a longitudinal direction thereof, an end portion closer to a bottom-line side is larger in lateral length (width) than an end portion closer to a neck-line side. The end portion at the neck-line side is concavely arc-shaped, in plan view of FIG. 4, with respect to the central piece 16a. A pair of side edge portions 29 are in an hourglass shape with a constriction in proximity to a center of a longitudinal direction, in plan view of FIG. 4, of the central piece 16a. The central piece 16a has five seam-line segments of filling-material partition stitch 32 formed thereon in a direction substantially perpendicular to a longitudinal direction thereof, and as a result, the central piece 16a has six filling-material accommodation spaces 40 formed among the seam-line segments in a longitudinal direction thereof.

Initially, FIG. 4 shows a front view of a front fabric 28 in (a) and a lining fabric 26 in (b) for the central piece 16a of the back panel 16. The lining fabric 26 is cut into a shape of the central piece 16a and has a seam allowance line 26a marked around an entire perimeter thereof. The front fabric 28 is cut into an hourglass shape obtained as a result of longitudinally enlarging the lining fabric 26 so as to form a surplus portion, in plan view, where a longitudinally enlarged ratio is, e.g., 1.2 times. The front fabric 28 has a lateral length laterally intersecting a longitudinal direction thereof (length in a width direction) that is the same in width as the lining fabric 26, and also has a seam allowance line 28c marked around an entire perimeter thereof, in plan view.

Subsequently, as shown in (c) of FIG. 4, the lining fabric 26 and the front fabric 28 are overlapped such that seam allowance lines 26a, 26a at both sides along longitudinal directions and seam allowance lines 28c, 28c at both sides along longitudinal directions match each other; the lining fabric 26 and the front fabric 28 are sewn together at a pair of ends in a longitudinal direction with edge stitch 30; and the lining fabric 26 and the front fabric 28 are further sewn together at five seam-line segments, in a longitudinal direction between the pair of ends, with filling-material partition stitch 32 in a direction substantially perpendicular to a longitudinal direction, i.e., substantially horizontal to the edge stitch 30.

Furter subsequently, as shown in (d) of FIG. 4, between both edges 29, 29 along longitudinal directions of the front fabric 28 for the central piece 16a, a pair of ends of the front fabric 28 with respect to filling-material partition stitch 32 on the central piece 16a are formed as a result of: folding alternatingly mountain and valley manner of the front fabric 28 along their respective fold lines substantially horizontal to the filling-material partition stitch 32; and arranging their respective mountain-fold lines 34, 34 adjacently to each other at the filling-material partition stitch 32 in a longitudinal direction, and thereby, a tuck 35 is formed for the central piece 16a. While forming tucks 35 at five seam-line segments of filling-material partition stitch 32, the lining fabric 26 and the front fabric 28 are sewn together with second edge stitch 36 around an entire perimeter thereof such that the seam allowance lines 26a, 26a and the seam allowance lines 28c, 28c match each other, and thereby, six filling-material accommodation spaces 40 are formed so as to be surrounded by second edge stitch 36 and filling-material partition stitch 32. One edge 29 of both edges 29, 29 along longitudinal directions of the central piece 16a is formed such that the second edge stitch 36 at the one edge 29 is stitch-free in part around a middle between a segment of edge stitch 30 and a segment of filling-material partition stitch 32 or around a middle between a pair of segments of filing-material partition stitch 32, and thereby, a filling-material insertion opening 38 is formed.

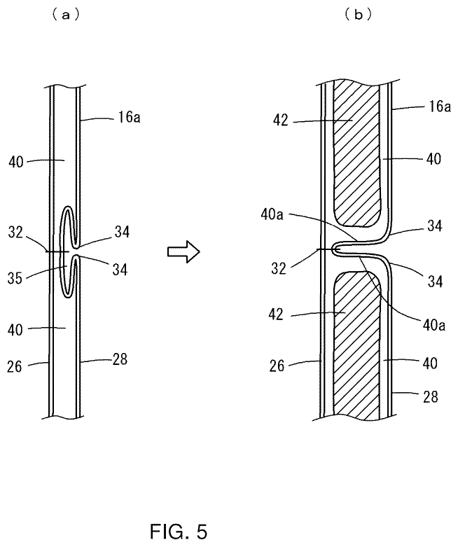

Still further subsequently, a step of inserting the filling material 42 into the filling-material accommodation space 40 is shown in FIG. 5. FIG. 5 depicts A-A line longitudinally cross-sectional views of (d) in FIG. 4. The state of the filling-material accommodation space 40 before the filling material 42 is inserted into it is shown in (a) of FIG. 5. In a state where the lining fabric 26 and the front fabric 28 are sewn together with edge stitch 30, filing-material partition stitch 32, second edge stitch 36, the front fabric 28 are in a state where a pair of fold lines 34, 34 thereof are adjacent to each other and thereby the tuck 35 folds, and for this reason, the filling-material accommodation space 40 is no longer thick and the lining fabric 26 and the front fabric 28 are overlapped.

Finally, after having finished inserting the filling-material 42 through the filling-material insertion opening 38 into the filling-material accommodation space 40, the filling-material insertion opening 38 is sewn so as to be closed. Upon insertion of the filling material 42, as shown in (b) of FIG. 5, the front fabric 28 is pushed up away from the filling material 42 so as to stand up in a three-dimensional manner from the lining fabric 26. The pair of fold lines 34, 34 are opened so as to have their respective angles of a substantially square, and thereby, the tuck 35 therebetween is opened and the filling-material accommodation spaces 40, 40 adjacent across such a tuck 35 to each other are formed into a rectangular parallelepiped shape, respectively. Since each filling-material accommodation space 40 is in a rectangular parallelepiped shape, the filling material 42 can be inserted into such spaces 40, 40 so as to have a substantially uniform thickness even in proximity to the filling-material partition stitch 32. The pair of filling-material accommodation spaces 40, 40 are adjacent to each other, without any significant gap defined by their respective baffle surfaces 40a, 40a facing mutually, and thereby, the filling-material accommodation spaces 40, 40 can be filled with their respective filling materials 42, 42 in a substantially continuous manner while maintaining a substantially uniform thickness. Then the central piece 16a is completed.

Secondary, the back panel 16 is formed as a result of sewing between the central piece 16a completed after having been filled with the filling material 42 and a pair of side pieces 16b, 16b, respectively, on a pair of edges 29, 29 along longitudinal directions, with joining stitch 44. It is to be noted that the side piece 16b is formed as a result of: sewing the lining fabric 26 and the front fabric 28 larger in size than the lining fabric 26 with the edge stitch 30, the filling-material partition stitch 32, and the second edge stitch 36 so as to form the filling-material accommodation space 40; and inserting the filling material 42 into the filling-material accommodation space 40, and thereby, the side piece 16b becomes in a three-dimensional shape, as a similar manner to that of the central piece 16a. The side piece 16b is, therefore, filled with the filling material 42 between the lining fabric 26 and the front fabric 28 to such an extent that a thickness thereof is substantially uniform.

As shown in FIG. 3, the seam line of joining stitch 44 between the central piece 16a and each side piece 16b is positioned slightly closer to the center than the seam line of second edge stitch 36 surrounding the central piece 16a. As a result, the mountain-fold lines 34 between their respective front fabrics 28, 28 of the central piece 16a and each side piece 16b are made continuous, thereby to form baffle surfaces 40b, 40b intersecting the baffle surfaces 40a, 40a of the central piece 16a and each side piece 16b as well as standing up substantially perpendicularly from the lining fabrics 26, 26, of the central piece 16a and each side piece 16b. The three-dimensional filling-material accommodation spaces 40, 40 of the central piece 16a and each side piece 16b, respectively, are adjacent to each other across the baffle surfaces 40b, 40b without any significant gap therebetween, thereby capable of being filled with the filling materials 42, 42 in a substantially uniform thickness. In other words, each filling-material accommodation space 40 is adjacent, at all four sides thereof, to other filling-material accommodation spaces 40, 40, 40, 40, without any significant gaps, and each filling material 42 accommodated therewithin has a substantially uniform thickness over a whole surface. It is to be noted that the order of the manufacturing steps is not limited to that described above.

For other portions of the jacket 10 than the back panel 16, i.e., for the hood portion 22, the front panel 14, the side portions 18, and the sleeve portions 20 as well, the front fabric 28, larger in size than the lining fabric 26 cut into a shape of each piece, is sewn to the lining fabric 26 with the edge stitch 30, filling-material partition stitch 32, and second edge stitch 36 in this order so as to form the filling-material accommodation space 40, and thereafter, the front fabric 28 is made in a three-dimensional manner as a result of inserting the filling material 42 into the filling-material accommodation space 40. As a result, the filling material 42 is inserted so as to have a substantially uniform thickness. The completed pieces are further sewn together with joining stitch 44 so as to form their respective portions, i.e., the hood portion 22, the back panel 16, the side portions 18, and the sleeve portions 20.

Thirdly, respective portions are sewn together with joining stitch 46 so as to manufacture the jacket 10. The jacket 10 is configured such that the front fabric 28 provided with the tucks 35 is pushed up away from the filling material 42 so as to stand up from the lining fabric 26 toward a wearer's body. The seam line of joining stitch 46 is positioned closer to the center of each portion than the seam lines of edge stitch 36 and joining stitch 44. This makes continuous the mountain-fold lines 34, 34 of the front fabrics 28, 28 of their respective adjoining portions, thereby to form baffle surfaces intersecting the baffle surfaces 40a or 40b as well as standing up substantially perpendicularly from the lining fabrics 26, 26. The filling-material accommodation spaces 40, 40 of their respective adjoining portions are adjacent to each other across the baffle surfaces, without any significant gaps, between the spaces 40, 40, and the filling material 42 accommodated therewithin has a substantially uniform thickness.

According to an embodiment of the present invention, the jacket 10 having a simple structure can be manufactured by a simple manufacturing method. With a uniform loft and good thermal insulation of the filling material 42, the jacket 10 has an increased contact area with a wearer thereby to provide a high level of heat retention. With such a simple manufacturing method of largely cutting the front fabric 28 so as to form a tuck 35, the filling-material accommodation spaces 40 each formed into a three-dimensional shape can be positioned so as to be adjacent to each other, thereby allowing the filling material 42 to be accommodated therewith having a substantially uniform thickness.

Further, according to an embodiment of the present invention, the following additional advantageous effects can be achieved. The filling material 42 does not become thinner around the filling-material partition stitch 32 on a seam line where the front fabric 28 and the lining fabric 26 are sewn together as well as the joining stitch 44, 46 on a seam line where the pieces are sewn together. This can reduce depressions on both outer and inner surfaces and can also reduce gaps between the filling-material accommodation spaces 40, 20 adjacent to each other likely to become cold spots, thereby capable of contributing to the expansion of dead air space. This leads to higher thermal insulation and enhanced level of heat retention, and a three-dimensional shape can be efficiently achieved even with a small amount of filling material 42, which can result in a higher level of heat retention. The amount of filling material 42 to be used can be reduced, thereby to provide economic advantages. In comparison to a conventional structure having an ordinary filling-material partition stitch, a greater loft can be achieved with the same amount of filling material 42. A three-dimensional shape can be efficiently achieved even with a small amount of filling material 42, which can result in a still higher level of heat retention. The amount of filling material 42 to be used can be reduced, and resultant reduction in the use of animal-derived down filling also contributes to animal welfare. Each filling-material accommodation space 40 can individually vary in shape so that it conforms more easily to the contours of a wearer's body, and thereby, the wearer's feeling of fit can be enhanced.

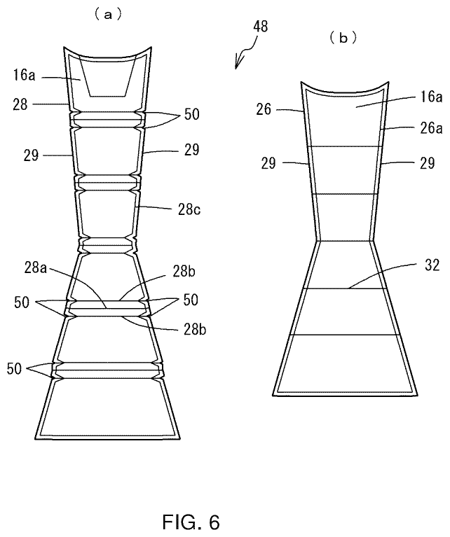

Next, a second embodiment of the present invention will be described with reference to FIG. 6. It is to be noted that components similar to those in the above-described embodiments are identified with the same reference numerals, and their detailed descriptions are omitted. A jacket 48 of a second embodiment includes three-dimensional filling-material accommodation spaces 40. Each of the filling-material accommodation spaces 40 is formed into a three-dimensional shape not through tucks 35 but through darts. FIG. 6 depicts a front view of a front fabric 28 (a) and a rear view of a lining fabric 26 (b) of a central piece 16a of a back panel 16 of the jacket 48. The lining fabric 26 of the jacket 48 cut into a shape of the central piece 16a has a seam allowance line 26a marked around an entire perimeter thereof. The front fabric 28 is also cut into a shape of a longitudinally enlarged shape of the lining fabric 26 so as to form a surplus portion. A longitudinally enlarged ratio is, e.g., 1.2 times.

The front fabric 28 has filling-material partition stitch lines 28a each marked at a position where the filling-material partition stitch 32 is to be formed. In proximity to each filling-material partition stitch line 28a, fold lines 28b are positioned so as to be substantially parallel to the stitch line 28a. A pair of fold lines 28b, 28b are positioned on both sides of each filling-material partition stitch line 28a at substantially equal intervals. On a pair of side edge portions 29, 29 extending along longitudinal directions, the front fabric 28 has a pair of dart cuts 50, 50 formed at their respective positions contacting the fold line 28b thereof, respectively. Each dart cut 50 has a V-shape, in plan view, having a vertex at a position contacting the corresponding fold line 28b. The front fabric 28 has a seam allowance line 28c marked around an entire perimeter thereof, and the seam allowance line 28c also has a V-shape along an inner side of the dart cut 50.

A forming method of forming the filling-material accommodation spaces 40 into a three-dimensional shape through the dart cut 50 will be described.

Initially, the front fabric 28 is mountain-folded along each fold line 28b while two adjacent edges of each V-shaped dart cut 50 being overlapped so as to be sewn together at an inner side thereof, and thereby, each dart is formed. The dart is thus formed at each end of each fold line 28b continuous with the corresponding side edge portion 29. The dart cut 50 with two adjacent edges sewn together at an inner side thereof is then turned inside out so that the outer surface becomes convex.

Subsequently, the lining fabric 26 and the front fabric 28 overlapped are sewn together with a pair of seam-line segments of edge stitch 30, 30 in a longitudinal direction such that seam allowance lines 26a, 26a at both sides along longitudinal directions of the lining fabric 26 and seam allowance lines 28c, 28c at both sides along longitudinal directions of the front fabric 28 match each other. Further, between the pair of seam-line segments of edge stitch 30, 30, the lining fabric 26 and the front fabric 28 are sewn together at five seam-line segments in a longitudinal direction with filling-material partition stitch 32 oriented substantially perpendicular to a longitudinal direction, i.e., substantially parallel to the pair of seam-line segments of edge stitch 30, 30 and along filling-material partition stitch lines 28a.

Further subsequently, inside a side edge portion 29 as well as outside the seam allowance line 28c, a notch is made on an extended portion of a filling-material partition stitch line 28a between a pair sides of a dart cut 50. While causing a tip of each dart and aligning the seam allowance line 26a and the seam allowance line 28c with each other, the lining fabric 26 and the front fabric 28 are secured together as a result of sewing around an entire perimeter thereof with second edge stitch 36. As a result, six filling-material accommodation spaces 40, 40, 40, 40, 40, 40 are formed, each of which is enclosed with the second edge stitch 36 and the filling-material partition stitch 32. At this stage, the second edge stitch 36 is interrupted at six locations so as to form filling-material insertion openings 38, 38, 38, 38, 38, 38. The filling material 42 is inserted through each filling-material insertion opening 38, and thereafter, the filing material 42 is sewn closed. The insertion of the filling material 42 pushes the front fabric 28 away from the filling material 42 so that the front fabric 28 stands up in a three-dimensional manner from the lining fabric 26. Due to a V-shape of each dart, the filling-material accommodation space 40 is formed into a shape of trapezoidal cube or a truncated square pyramid shape. The subsequent manufacturing steps are similar to those for the jacket 10 of the above-described embodiments, which is formed through the tucks 35.

According to the jacket 48 of a second embodiment, by virtue of dart cuts 50, the filling-material accommodation space 40 defined by a rectangular top surface parallel to the lining fabric 26 and baffle surfaces 40a, 40a, 40b, 40b extending continuously from four sides of the top surface can be formed into a well-defined three-dimensional shape. As a result, the filling material 42 can be inserted into the filling-material accommodation spaces 40, 40 so as to have a substantially uniform thickness even in proximity to the filling-material partition stitch 32. In contrast to the above-described jacket 10 with tucks 35 having an blank area without having any filling material 42 formed at an intersection between the filling-material partition stitch 32 and the joining stitch 44, 46, the dart cuts 48 in a second embodiment can prevent the formation of such blank areas, which results in a higher level of heat retention.

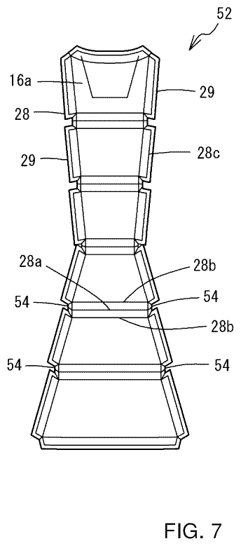

Next, a third embodiment of the present invention will be described with reference to FIG. 7. It is to be noted that components similar to those in the above-described embodiments are identified with the same reference numerals, and their detailed descriptions are omitted. In a jacket 52 of a third embodiment as well, darts are used to make the filling-material accommodation space 40 in a three-dimensional manner, which is similar to that of the above-described jacket 48 of the second embodiment. FIG. 7 depicts a front view of the front fabric 28 in the central piece 16a for the back panel 16 of the jacket 52. It is to be noted that the lining fabric 26 is the same in shape as that of the above-described jacket 48 of the second embodiment, and thus its detailed description is omitted.

The front fabric 28 has filling-material partition stitch lines 28a each marked at a position where the filling-material partition stitch 32 is to be formed. A pair of fold lines 28b, 28b are positioned on both sides of each filling-material partition stitch line 28a. The front fabric 28 has U-shaped dart cuts 54, 54, 54, 54, 54 formed, in each side edge 29 extending along a longitudinal direction, at portions continuous with their respective filling-material partition stitch lines 28a, 28a, 28a, 28a, 28a. Each dart cut 54 has two corners continuous with their respective fold lines 28b, 28b. The seam allowance line 28c also has U-shaped portions along their respective dart cuts 54, 54, 54, 54, 54.

A forming method of forming the filling-material accommodation spaces 40 into a three-dimensional shape through the dart cut 50 will be described.

Initially, the front fabric 28 is mountain-folded along each fold line 28b while two adjacent edges surrounding each corner of the U-shaped dart cut 54 being overlapped so as to be sewn together at an inner side thereof, and thereby, each dart is formed. Each dart cut 54 has two corners made so that two darts are formed from each dart cut 54. Two darts are thus formed at each end of each fold line 28b continuous with the corresponding side edge 29. The dart cut 54, sewn with the right sides facing, is then turned inside out so that the outer surface becomes convex.

Subsequently, the lining fabric 26 and the front fabric 28 overlapped are sewn together with a pair of seam-line segments of edge stitch 30, 30 in a longitudinal direction such that seam allowance lines 26a, 26a at both sides along longitudinal directions of the lining fabric 26 and seam allowance lines 28c, 28c at both sides along longitudinal directions of the front fabric 28 match each other. Further, between the pair of seam-line segments of edge stitch 30, 30, the lining fabric 26 and the front fabric 28 are sewn together at five seam-line segments in a longitudinal direction with filling-material partition stitch 32 oriented substantially perpendicular to a longitudinal direction, i.e., substantially parallel to the pair of seam-line segments of edge stitch 30, 30 and along the filling-material partition stitch lines 28a.

Further subsequently, inside a side edge portion 29 as well as outside the seam allowance line 28c, a notch is made on an extended portion of a filling-material partition stitch line 28a between a pair of sides of a dart cut 54. While causing a tip of each dart and aligning the seam allowance lines 26a and 28c with each other, the lining fabric 26 and the front fabric 28 are secured together as a result of sewing around an entire perimeter thereof with second edge stitch 36 in a similar manner to that of the above-described embodiment. As a result, six filling-material accommodation spaces 40, 40, 40, 40, 40, 40 are formed, each of which is enclosed with the second edge stitch 36 and the filling-material partition stitch 32. At this stage, the second edge stitch 36 is interrupted at six locations so as to form filling-material insertion openings 38, 38, 38, 38, 38, 38. The filling material 42 is inserted through each filling-material insertion opening 38, and thereafter, the filling material 42 is sewn closed. The insertion of the filling material 42 pushes the front fabric 28 away from the filling material 42 so that the front fabric 28 stands up in a three-dimensional manner from the lining fabric 26. Due to a U-shape of each dart, the filling-material accommodation space 40 is formed into a rectangular parallelepiped shape. The subsequent manufacturing steps are similar to those for the jacket 48 of the above-described second embodiment, which is formed through the dart cuts 50.

According to the jacket 52 of a third embodiment, by virtue of dart cuts 54, filling-material accommodation space 40 defined by a rectangular top surface parallel to the lining fabric 26 and the baffle surfaces 40a, 40a, 40b, 40b extending continuously and substantially perpendicularly from four sides of the top surface can be formed into a well-defined a rectangular parallelepiped shape. As a result, the filling material 42 can be inserted into the filing-material accommodation spaces 40, 40 so as to have a substantially uniform thickness even in proximity to the filling-material partition stitch 32. The filling-material accommodation spaces 40 are adjacent to each other across the baffle surfaces 40a, 40a standing up substantially perpendicularly from the lining fabric 26 so that the filling material 42 can be charged without any significant gaps, which results in a higher level of heat retention.

It is to be noted that the filling-material filled cloth product of the present invention is not limited to the products of the above-described embodiments, and the order of the sewing steps may differ from those of the above-described embodiments. The surplus portion may be formed through a combination of tuck, dart, and the like, and the position and number of the filling-material partition stitch as well as the shape of the filling-material accommodation space, can be arbitrarily modified. In addition to the jacket, the present invention can be used to produce various other padded garments and cloth products having heat-retention functions, such as pants, sleeping bags, and comforters. The filling material is not limited to down, and can be arbitrarily selected from synthetic fibers, cotton, and other materials. A single product may include both filling-material accommodation spaces formed by tucks and those formed by darts. Each of the lining fabric and the front fabric may be formed from multiple pre-layered fabrics. The filling material may be in a shape of a triangular prism or other polygonal prisms, besides the rectangular parallelepiped shape.

### EXAMPLES

A heat retention test was conducted on the filling-material filled cloth product of the present invention in order to compare the heat retention performance based upon power consumption. Samples in the form of a 20 cm×20 cm cushion were prepared (N=3). Environmental conditions for the test were as follows: room temperature 20° C., humidity 65%, hot plate temperature 30° C., and wind velocity 0.3 m/s. The comparison was based upon the 10-minute average value from 50 to 60 minutes (stable period) of the 60-minute standing time. For comparison, a comparative sample of the same size was prepared through filling-material partition stitch similar to the seams of the padded garments disclosed in Patent Document 1.

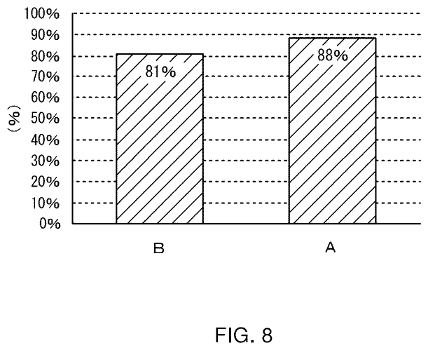

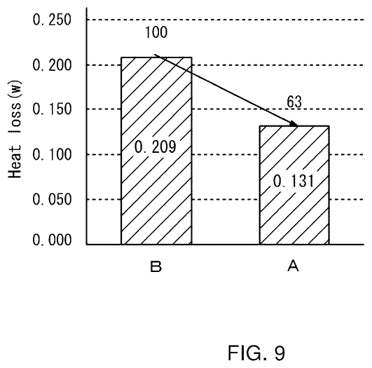

The results of heat retention rates are shown in FIG. 8. While the heat retention rate of Comparative Sample B was 81%, that of Present Invention Product A was 88%. This demonstrates that Present Invention Product A has higher heat retention than Comparative Sample B. The results of power consumption are shown in FIG. 9. A lower value of power consumption Heat loss (W) indicates greater warmth. The power consumption for Comparative Sample B was 0.209 W, while that for Present Invention Product A was 0.131 W. In a relative comparison, when the power consumption for Comparative Sample B was taken as 100%, that for Present Invention Product A was 63%. This demonstrates that Present Invention Product A provides improved warmth.

These results indicate that the improved design of stitch in Present Invention Product A enhances a contact area with a skin surface and reduces gaps between the filling-material accommodation spaces 40 at cold spots, leading to improved heat retention. In other words, even with the use of filling material 42 with the same loft and amount of down, the novel stitching method can reduce surface depressions on both outer and inner surfaces and contribute to the expansion of dead air space, which is believed to be a reason for the improved heat retention.

### REFERENCE NUMERALS

10, 48, 52 Jacket
26 Lining fabric
28 Front fabric
32 Filling-material partition stitch
35 Tuck
40 Filling-material accommodation space
42 Filling material
50, 54 Dart cut

What is claimed is:

1. A filling-material filled cloth product comprising:
a pair of fabrics layered together and sewn peripherally at filling-material partition stitch defining therein a bag-shaped filling-material accommodation space; and
a thermally insulating filling material accommodated within the bag-shaped filling-material accommodation space,
wherein one fabric of the pair of fabrics is cut so as to be larger than the other fabric of the pair of fabrics so that the one fabric having a surplus portion in proximity to the filling-material partition stitch made as a result of largely cutting is pushed up away from the filling material so as to stand up in a three-dimensional manner from the other fabric, and thereby, the filling-material accommodation space is three-dimensionally shaped so as to accommodate the filling material having a substantially uniform thickness in proximity to the filling-material partition stitch.

2. The filling-material filled cloth product according to claim 1, wherein the surplus portion has a tuck formed on the one fabric.

3. The filling-material filled cloth product according to claim 2, wherein one fabric of the pair of fabrics is a front fabric to be positioned so as to face a wearer's body side, and the other fabric of the pair of fabrics is a lining fabric to be positioned so as to be opposite to the wearer's body side, and wherein the front fabric is cut so as to be larger than the lining fabric so that the front fabric having a tuck formed thereon is pushed up away from the filling material so as to stand up in a three-dimensional manner from the lining fabric.

4. The filling-material filled cloth product according to claim 3, wherein the filling-material accommodation space includes a plurality of filling-material accommodation spaces adjacent to each other.

5. The filling-material filled cloth product according to claim 3, wherein said filling-material filled cloth product is a jacket.

6. The filling-material filled cloth product according to claim 3, wherein the filling material is made of down.

7. The filling-material filled cloth product according to claim 1, wherein the surplus portion has a dart formed on the one fabric.

8. The filling-material filled cloth product according to claim 7, wherein one fabric of the pair of fabrics is a front fabric to be positioned so as to face a wearer's body side, and the other fabric of the pair of fabrics is a lining fabric to be positioned so as to be opposite to the wearer's body side, and wherein the front fabric is cut so as to be larger than the lining fabric so that the front fabric having a dart formed thereon is pushed up away from the filling material so as to stand up in a three-dimensional manner from the lining fabric.

9. The filling-material filled cloth product according to claim 8, wherein the filling-material accommodation space includes a plurality of filling-material accommodation spaces adjacent to each other.

10. The filling-material filled cloth product according to claim 8, wherein said filling-material filled cloth product is a jacket.

11. The filling-material filled cloth product according to claim 8, wherein the filling material is made of down.
